(19) United States
(12) Patent Application Publication
(10) Pub. No.: US 2002/0076166 A1
(43) Pub. Date: Jun. 20, 2002

(54) Optical fiber junction

(76) Inventor: Cheng-Sheng HSU, Tainan (TW)

Correspondence Address: Rider Bennett Egan & Arundel, 333 South Seventh Street Suite 2000, Minneapolis, MN, 55402, US

(21) Appl. No.: 09/742,565

(22) Filed: Dec. 20, 2000

(51) Int. Cl. G02B 6/36

(52) U.S. Cl. 385/78

(57) ABSTRACT

An optical fiber junction includes a tube having an upper end and a lower end. The tube has a flange formed between the ends and an annular groove defined in an outer periphery thereof between the flange and the lower end. The tube defines a first channel extending from the upper end towards the lower end for receiving a core of an optical fiber, and a second channel in communication with the first channel and extending from the lower end towards the upper end for receiving the optical fiber. A sleeve has a collar and is positioned above the annular groove of the tube after the tube is inserted into the sleeve. A spring is provided between the flange and the collar. A resilient retainer ring is held in the annular groove of the tube.

### BACKGROUND OF THE INVENTION

1. Field of the Invention

The present invention relates to an optical fiber junction and, more particularly, to an optical fiber junction which is easy to be manufactured and assembled.

2. Description of Related Art

Many types of optical fiber junctions are known. FIG. 4 illustrates an optical fiber junction (5) that includes a tubular member (50), a sleeve (60), a spring (70) and a C-shaped retainer ring (80).

Referring to FIG. 5, the tubular member (50) has a first porcelain end (51) and a second barbed end (55), and includes a flange (53) formed thereon and an annular groove (54) defined between the flange (53) and the second end (55). The tubular member (50) defines a first channel (52) in the first end (51) for receiving a core of an optical fiber, and a second channel (56) extending from the second end (55) to the first channel (52) for receiving the optical fiber itself.

The sleeve (60) includes a chamber (61) for receiving the tubular member (50) and an inwardly projected collar (62) normally located immediately above the annular groove (54) of the member (50). The spring (70) is mounted around the tubular member (50), and between the flange (53) and the collar (62), and the retainer ring (80) is held in the annular groove (54) of the member (50).

Referring to FIG. 6, this conventional junction (5) is assembled by means of mounting the spring (70) around the tubular member (50) and passing the second end (55) of the member (50) through the chamber (61) of the sleeve (60). Then, it is necessary to expose the annular groove (54) from the sleeve (60) by urging the first end (51) of the tubular member (50), against the spring (70), towards the sleeve (60) to place the C-shaped ring (80) in the groove (54).

In the assembly process, however, great effort must be taken to compress the spring (70). Additionally, the sleeve (60) is required to have a particular color to identify the diameter of the first channel (52), which generally varies depending on the standardized model of the optical fiber to be connected.

Therefore, it is an objective of the invention to provide an optical fiber junction to mitigate and/or obviate the aforementioned problems.

### SUMMARY OF THE INVENTION

The object of the present invention is to provide an optical fiber junction which is easy to be manufactured.

Another object of the present invention is to provide an optical fiber junction which is easy to be assembled.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of a preferred embodiment of an optical fiber junction in accordance with the present invention;

FIG. 2 is a cross-sectional view of the optical fiber junction shown in FIG. 1;

FIG. 3 is a cross-sectional view showing the optical fiber junction of FIG. 1 in an assembly process;

FIG. 4 is an exploded perspective view of a conventional optical fiber junction;

FIG. 5 is a cross-sectional view of the conventional optical fiber junction shown in FIG. 4; and

FIG. 6 is a cross-sectional view showing the conventional optical fiber junction of FIG. 4 in an assembly process.

### DETAILED DESCRIPTION OF THE PREFERRED EMBODIMENT

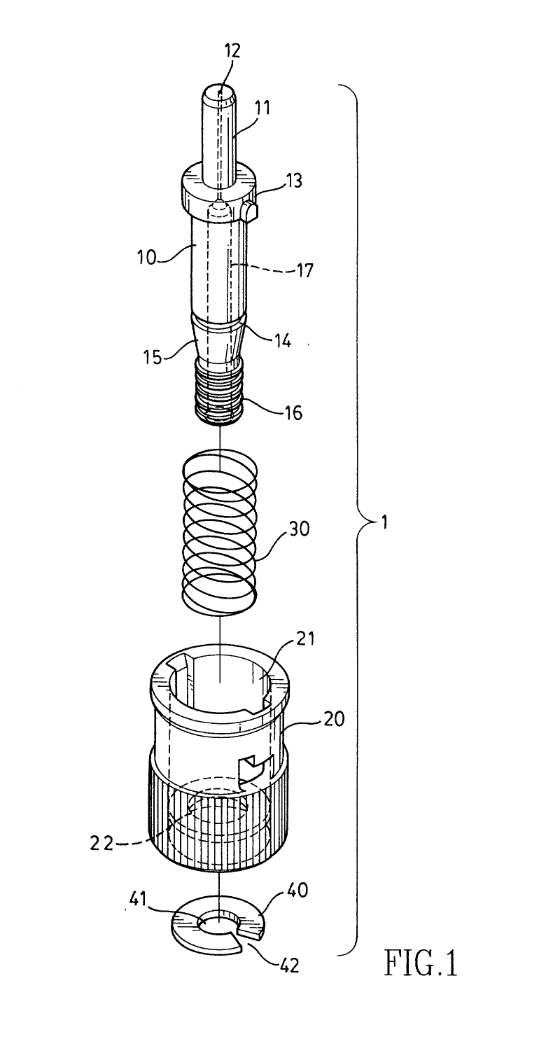

Referring to FIG. 1, an optical fiber junction (1) in accordance with the present invention includes a tubular member (10), a sleeve (20) surrounding and a spring (30) mounted around the tubular member (10). A resilient retainer ring (40) of the type having a through-hole (41) and a notch (42) is held in place on the member (10).

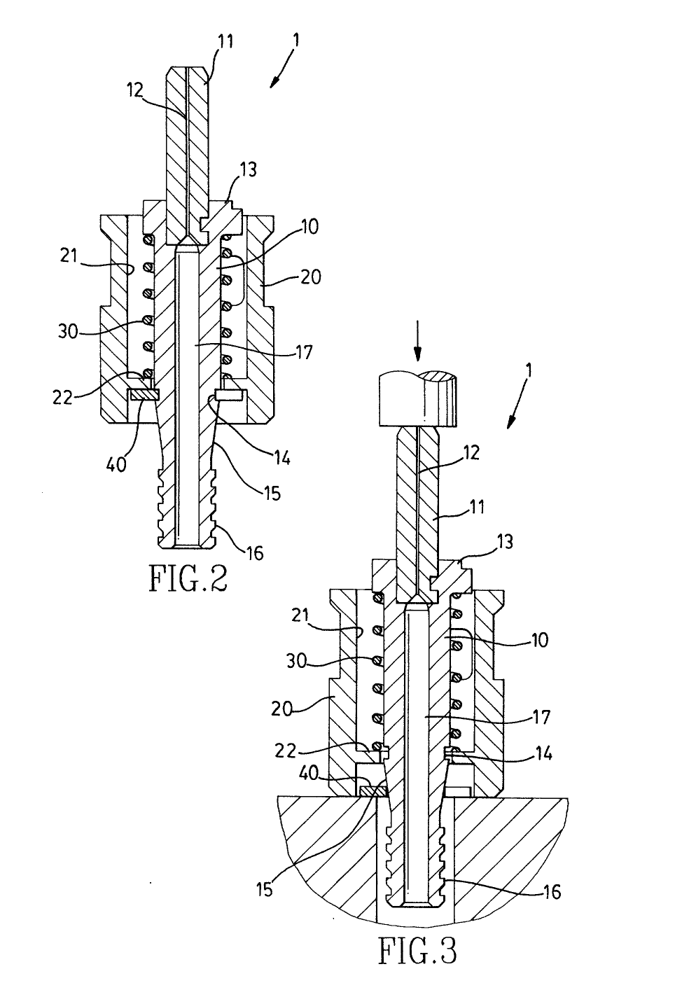

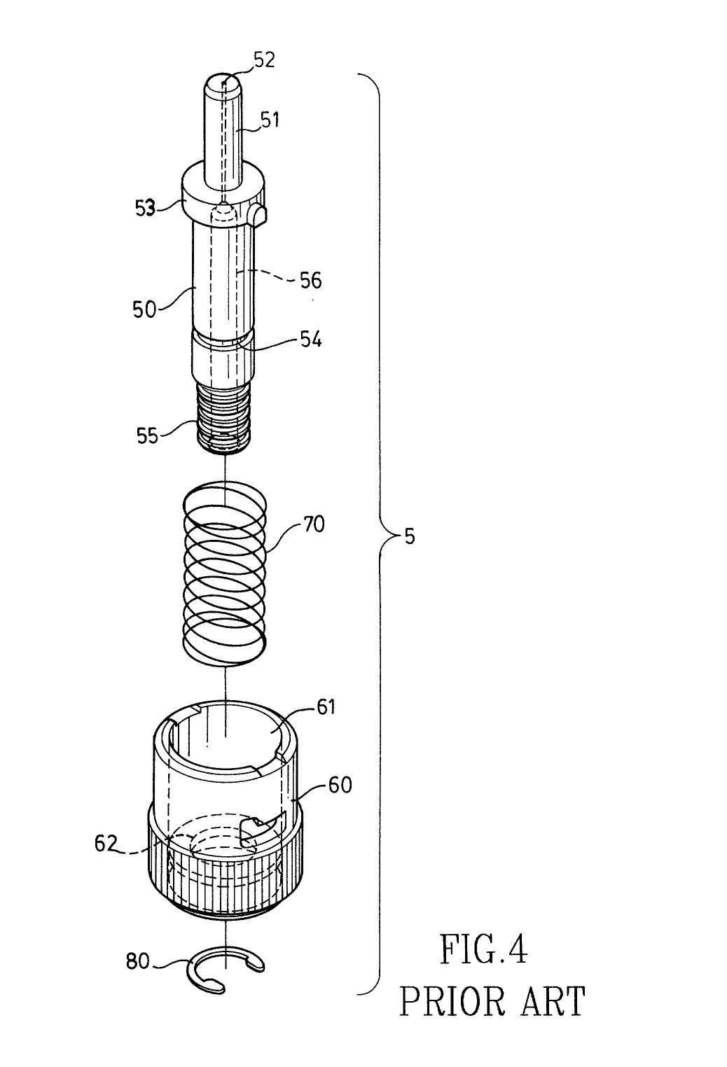

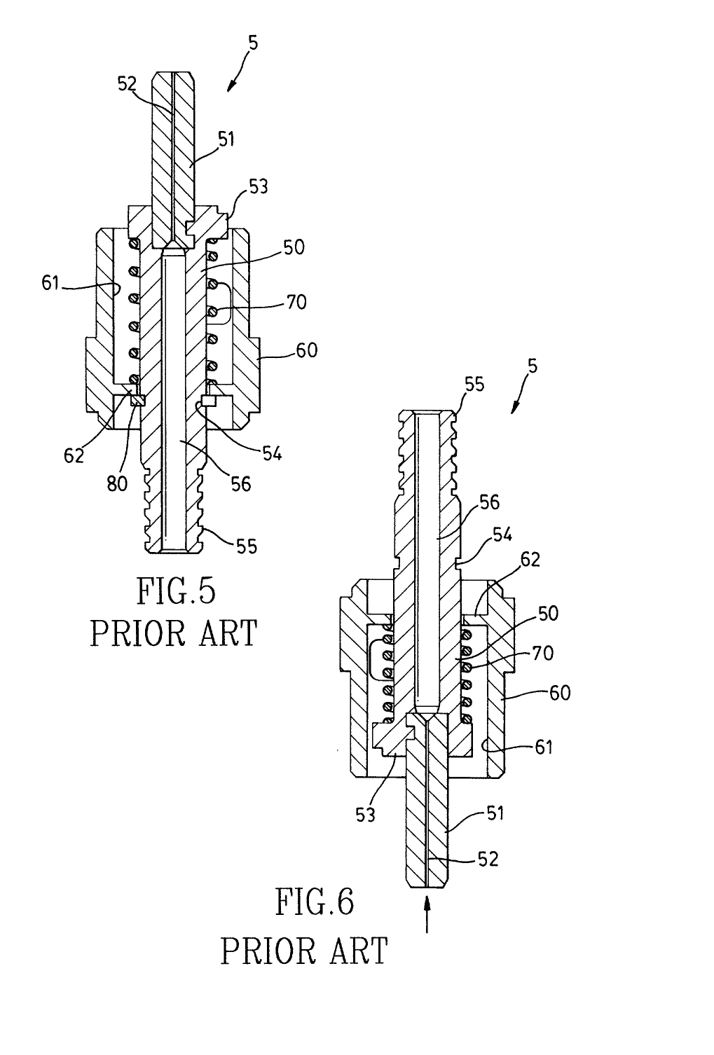

Referring to FIG. 2, the tubular member (10) has an upper end (11) and a lower end (16), and includes a flange (13) formed between the ends (11, 16) and an annular groove (14) defined in an outer periphery thereof between the flange (13) and the lower end (16). Preferably, the tubular member (10) has a section (15) that is tapered from the annular groove (14) towards the lower end (16).

Furthermore, the tubular member (10) defines a first channel (12) extending from the upper end (11) towards the lower end (16) for receiving a core of an optical fiber, and a second channel (17) in communication with the first channel (17) but extending from the lower end (16) towards the upper end (11) for receiving the optical fiber itself.

The member (10) may be made of plastic or kirksite except at its upper section, which, however, is in the nature of porcelain, as denoted by hitchings different from those for the other parts of the member (10).

The sleeve (20) includes a chamber (21) that receives the tubular member (10). The chamber (21) is defined by an inner periphery of the sleeve (20) from which a collar (22) is projected inward and normally located immediately above the annular groove (14) of the member (10). The spring (30) is mounted around the tubular member (10) just between the flange (13) of the tubular member (10) and the collar (22) of the sleeve (20), while the resilient retainer ring (40) is held in the annular groove (14) of the member (10).

In the inventive optical fiber junction (1), the resilient retainer ring (40) is made of plastic in a particular color associated with a diameter of the first channel (12).

Referring to FIG. 3, the optical fiber junction (1) is assembled by mounting the spring (30) around the tubular member (10) in a location beneath the flange (13), and by passing the lower end (16) of the member (10) through the chamber (21) of the sleeve (20).

Then, the resilient retainer ring (40) is held on the tubular member (10) at its tapered section (15), before the member (10) is pressed downward relative to the ring (40), such as by a press device, until the resilient ring (40) snaps into the annular groove (14) of the tubular member (10).

From the above description, it is noted that the invention has the following advantages:

1. simple manufacture:

Because the resilient retainer ring (40) is made of plastic, it can be made in one of various colors as a mark to identify an inner diameter of the first channel (12).

2. mechanized assembly:

Because of the tapered section (15) of the tubular member (10), the resilient retainer ring (40) may be placed in the annular groove (14) of the member (10) by the press device.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An optical fiber junction (1) for holding an end of an optical fiber with a core, comprising:
a tubular member (10) having an upper end (11) and a lower end (16), said tubular member (10) having a flange (13) formed between said ends (11, 16) and an annular groove (14) defined in an outer periphery thereof and positioned between said flange (13) and said lower end (16);
said tubular member (10) defining a first channel (12) extending from said upper end (11) towards said lower end (16) for receiving said core of said optical fiber, and a second channel (17) defined to communicate with said first channel (12) and extend from said lower end (16) towards said upper end (11) for receiving said optical fiber;
a sleeve (20) having a chamber (21) defined to receive therein the tubular member (10), a collar (22) projected from an inner periphery thereof and located immediately above said annular groove (14) of said tubular member (10);
a spring (30) mounted around said tubular member (10) and abutted between said flange (13) of said tubular member (10) and said collar (22) of said sleeve (20) after the tubular member (10) is received in the chamber (21); and
a resilient retainer ring (40) held in said annular groove (14) of said tubular member (10),
wherein said resilient retainer ring (40) is made of plastic and associated with a diameter of said first channel (12) of said tubular member (10).

2. The optical fiber junction (1) as claimed in claim 1, wherein said tubular member (10) has a section (15) tapered from said annular groove (14) towards said lower end (16).
